(19) United States
(12) Patent Application Publication
(10) Pub. No.: US 2008/0217432 A1
(43) Pub. Date: Sep. 11, 2008

(54) SEALING CONNECTION ASSEMBLY FOR A HANDHELD SHOWERHEAD ASSEMBLY

(76) Inventor: Chao-Chang Wu, Taichung (TW)

Correspondence Address: Rabin & Berdo, P.C., Suite 500, 1101 14th Street, Washington, DC, 20005, US

(21) Appl. No.: 11/684,063

(22) Filed: Mar. 9, 2007

(51) Int. Cl. B05B 1/00

(52) U.S. Cl. 239/254

(57) ABSTRACT

A sealing connection assembly for a handheld showerhead assembly has a base, a connecting assembly, a check valve and a locking nut. The base has a channel defined through the base. The connecting assembly is mounted inside the base and has a passage communicating with the channel. The check valve is mounted inside the passage of the connecting assembly to keep water from flowing back. The locking nut is used to connect a flexible hose to a handheld showerhead. The elements of the sealing connection assembly for a showerhead assembly are simple and are mounted inside the handheld showerhead. Therefore, repairing the sealing connecting assembly for a hand showerhead assembly is easy, and the appearance of the handheld showerhead is aesthetic.

### BACKGROUND OF THE INVENTION

1. Field of the Invention

The present invention relates to a sealing connection assembly, and more particularly to a sealing connection assembly for a handheld showerhead assembly that has a simplified structure.

2. Description of the Related Art

Handheld showerheads are very common. With reference to FIG. 5, a handheld showerhead (50) has a flexible hose (60) and a check valve (80). The flexible hose (60) is used to connect the handheld showerhead (50) to a faucet (70). The faucet (70) has an outlet. The check valve (80) is attached to the outlet of the faucet (70) to keep water from leaking or flowing back into the faucet (70) or dirty water from contaminating the faucet (70). With further reference to FIG. 6, the check valve (80) has a cap (81), a spring (82), a valve rod (83), a first sealing tap (84), a valve body (85), a second sealing tap (86), a connector (87) and other parts. The elements and structure of the check valve (80) are complex, and assembling the check valve (80) is time-consuming. Further, the check valve (80) is mounted outside the handheld showerhead (50), is not aesthetically pleasing and leaks easily.

To overcome the shortcomings, the present invention provides a sealing connection assembly for a handheld showerhead to obviate or mitigate the aforementioned problems.

### SUMMARY OF THE INVENTION

The primary objective of the present invention is to provide a sealing connection assembly for a handheld showerhead that is simplified and convenient to use.

A sealing connection assembly for a handheld showerhead in accordance with the present invention has a base, a connecting assembly, a check valve and a locking nut. The base has a channel defined through the base. The connecting assembly is mounted inside the base and has a passage communicating with the channel. The check valve is mounted inside the passage of the connecting assembly to keep water from flowing back. The locking nut is used to connect a flexible hose to the handheld showerhead.

The elements of the sealing connection assembly for a showerhead assembly are simple and are mounted inside the handheld showerhead between the flexible hose and the handheld showerhead. Therefore, repairing the sealing connecting assembly for a handheld showerhead assembly is easy, and the appearance of the handheld showerhead is aesthetically pleasing.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of a sealing connection assembly for a handheld showerhead in accordance with the present invention;

FIG. 2 is an exploded perspective view of the sealing connection assembly in FIG. 1;

FIG. 3 is an enlarged side view in partial section of the sealing connection in FIG. 1;

FIG. 4 is an enlarged operational side view in partial section of the sealing connection assembly in FIG. 1;

FIG. 5 is a side view of a conventional showerhead assembly in accordance with the prior art attached to a faucet; and

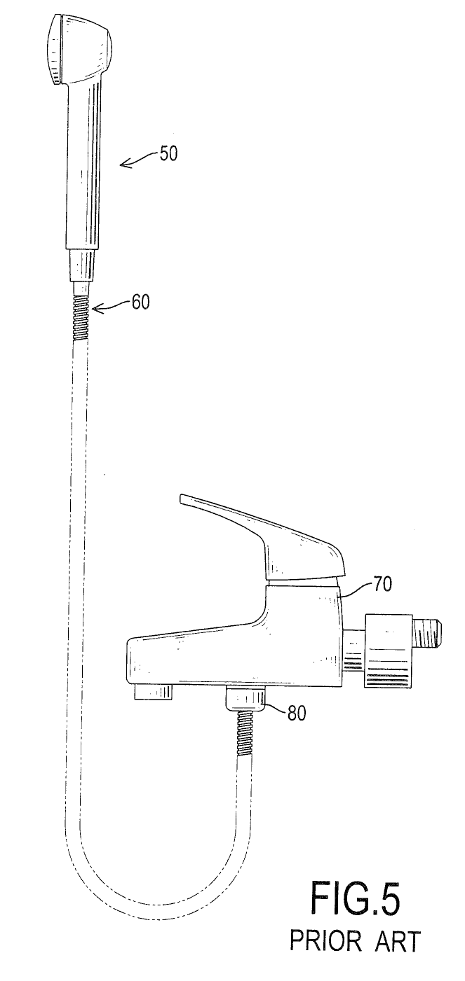

FIG. 6 is an exploded side view in partial section of a check valve of the conventional showerhead assembly in FIG. 5.

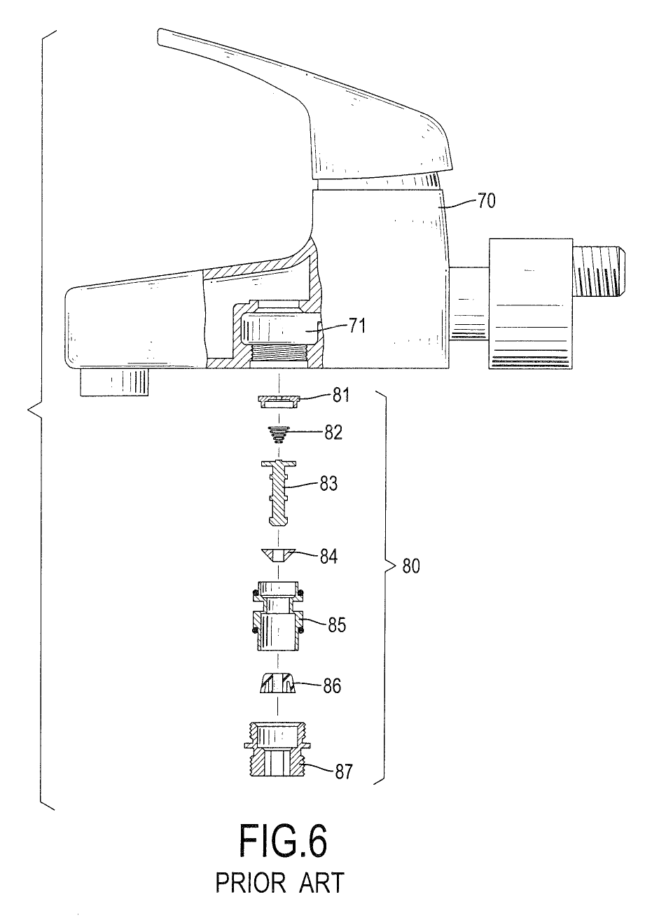

### DETAILED DESCRIPTION OF THE INVENTION

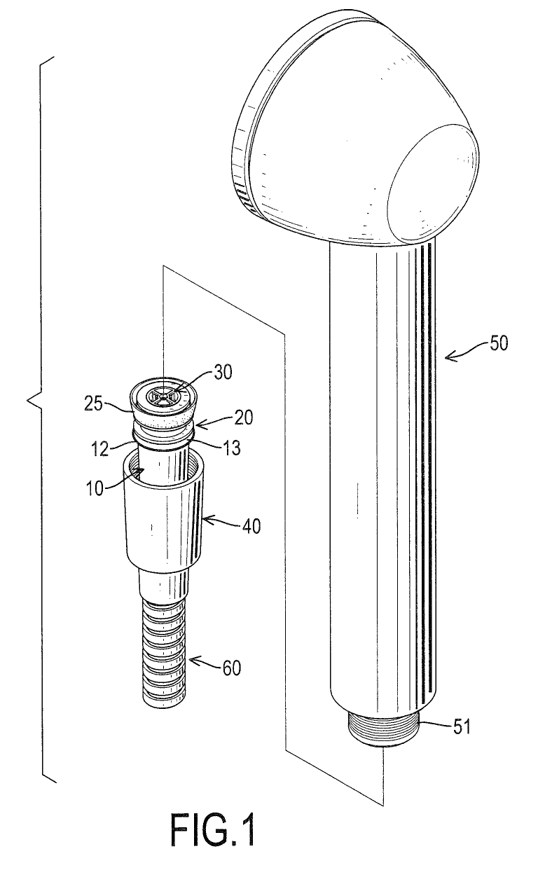

With reference to FIG. 1, a sealing connection assembly for a handheld showerhead assembly in accordance with the present invention is mounted in a handheld showerhead assembly having a flexible hose (60), a handheld showerhead (50) and a sealing connection assembly. The flexible hose (60) may be any type of conventional flexible hose that is heatproof and an internal channel through which water passes. The handheld showerhead (50) may be any kind of handheld showerhead (50), and the specific handheld showerhead (50) used in the description is intended to be illustrative of typical handheld showerhead and should not limit the scope of the invention. The handheld showerhead (50) has an inlet and an external thread (51).

The sealing connection assembly has a base (10), a connecting assembly (20), a check valve (30) and a locking nut (40).

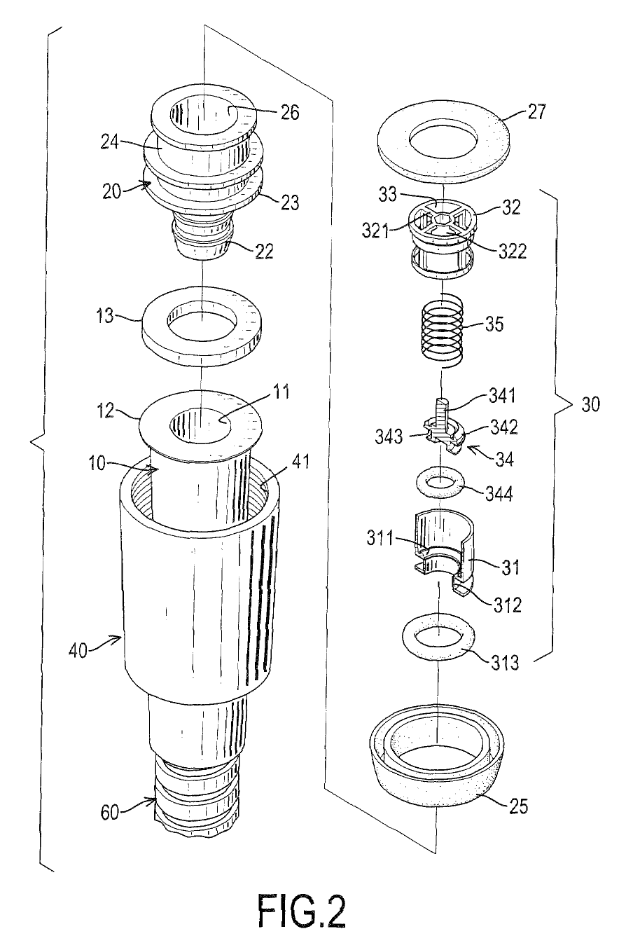

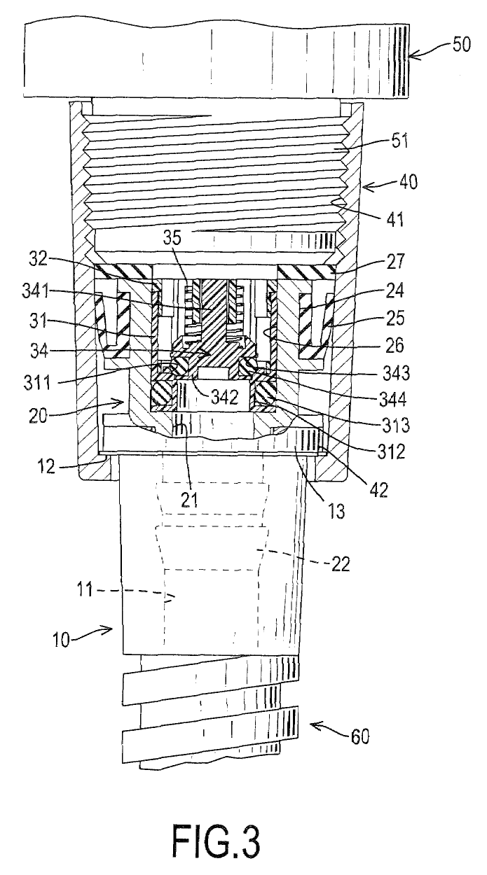

With further reference to FIGS. 2 and 3, the base (10) is cylindrical and hollow and has a center, an inner end, an outer end, a channel (11), a flange (12) and an optional gasket (13). The channel (11) is formed longitudinally through the base (10) and communicates with the channel in the flexible hose (60). The flange (12) is formed on and extends radially out from the inner end of the base (10). The gasket (13) is waterproof material and is mounted concentrically on the flange (12) to form a watertight seal.

The connecting assembly (20) is made of metal and tubular, is preferably made of a non-corrosive metal like copper, is mounted inside the base (10) and has a center, an outer surface, a proximal end (26), a distal end (22), a passage (21), two flanges (23), an annular recess (24), an annular gasket (25) and a flat gasket (27). The distal end (22) is mounted tightly inside the channel (11) in the base (10). The passage (21) is defined longitudinally through the connecting assembly (20) and is larger at the proximal end (26) than the distal end (22). The flanges (23) are formed on and protrude radially out from the outer surface of the connecting assembly (20). The annular recess (24) is defined in the outer surface near the proximal end (26) of the connecting assembly (20). The annular gasket (25) is resilient and semi-rigid, may be made of rubber, is mounted in the annular recess (24) and may have a U-shaped or any appropriate shaped cross section. The U-shaped annular gasket (25) has an open top facing the proximal end of the connecting assembly (20). The flat gasket (27) is waterproof and flexible material and is mounted on the annular gasket (25) to further prevent water from leaking between the showerhead (50) and the flexible hose (60).

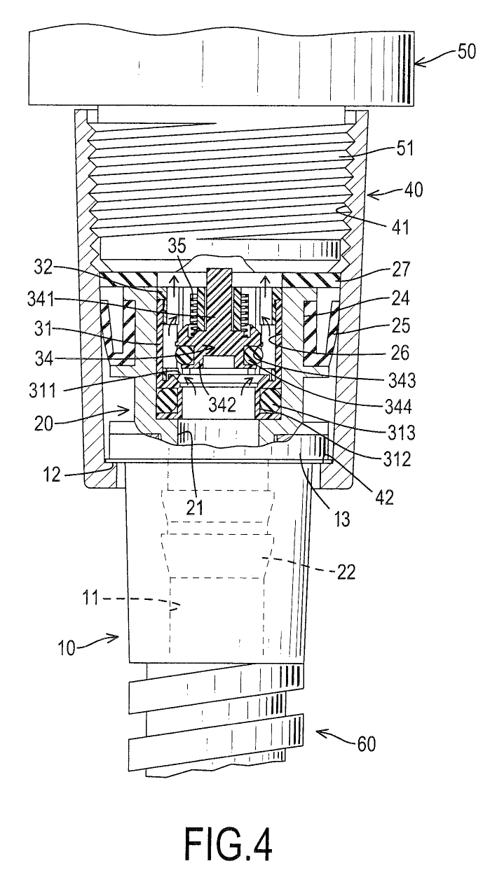

With further reference to FIG. 4, the check valve (30) is mounted inside the passage (21) at the proximal end (26) of the connecting assembly (20), only allows water to flow from the flexible hose (60) into the handheld showerhead (50) and may be a seat and disk check valve, a ball check valve, a membrane check valve or the like.

The seat and disk check valve has a valve body (31), a cap (32), a valve disk (34) and a spring (35). The valve body (31) is tubular and has an inner surface, an inner end, an outer end, a seat (311), an outer annular groove (312) and an outer O-ring (313). The seat (311) is formed on and protrudes in from the inner surface of the valve body (31) near the inner end. The outer annular groove (312) is formed in the valve body (31) at the inner end. The outer O-ring (313) is mounted in the outer annular groove (312) and provides a watertight seal between the connecting assembly (20) and the valve body (31). The cap (32) is tubular, is mounted tightly on the outer end of the valve body (31) and has multiple ribs (321), a central tube (322) and multiple channels (33). The ribs (321) are formed inside the cap (32) and protrude inward, and each rib (321) has an inner end. The central tube (322) is formed on the inner ends of the ribs (321) and extends longitudinally through the cap (32). The channels (33) are formed respectively between adjacent ribs (321) and allow water to flow through the cap (32). The valve disk (34) is mounted movably inside the valve body (31) and in the central tube (322) in the cap (32) and has a valve rod (341), a disk (342), an inner annular groove (343) and an inner O-ring (344). The valve rod (341) is mounted movably in the central tube (322) in the cap (32) and has an outer end and an inner end. The disk (342) is formed on the outer end of the valve rod (341) and has an outer edge. The inner annular groove (343) is defined in the outer edge of the disk (342). The inner O-ring (344) is mounted in the inner annular groove (343) and selectively abuts the seat (311) in the valve body (31) to close the check valve. The spring (35) is mounted around the valve rod (341) between the cap (32) and the valve disk (34) and presses the valve disk (34) against the valve seat (311) when water is not flowing through the flexible hose (60).

The locking nut (40) is a slightly tapered tube, is mounted around the base (10), connects the handheld showerhead (50) to connect the flexible hose (60) to the handheld showerhead (50) and has an outer end, an inner end, a channel, an inner thread (41) and an inner annular lip (42). The channel is defined longitudinally through the locking nut (40). The inner thread (41) is formed adjacent to the inner end of the locking nut (40) and screws onto the external thread (51) on the handheld showerhead (50). The inner annular lip (42) is formed on and protrudes radially in from the outer end of the channel to hold the flange (12) of the base (10).

The advantages of the showerhead assembly described follow.

1. The elements for assembling the check valve are simplified, and installing the check valve is easy.

2. Since the check valve is mounted inside the showerhead, the volume is small and overall appearance is aesthetically pleasing.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A sealing connection assembly for a handheld showerhead assembly, the showerhead assembly comprising a flexible hose having a channel defined inside the soft tube, and a handheld showerhead having an inlet end and a external thread, and the sealing connection assembly comprising
a base being cylindrical and hollow and having
a center;
an inner end;
an outer end,
a channel being formed longitudinally through the base and adapted for communicating with the channel in the flexible hose, and
a flange being formed on and extending radially out from the inner end of the base.
a connecting assembly being tubular, being mounted inside the base and having
a center,
an outer surface,
a proximal end,
a distal end being mounted tightly inside the channel in the base, and
a passage being defined longitudinally through the connecting assembly and being larger at the proximal end than the distal end,
a check valve being mounted inside the passage at the proximal end of the connecting assembly to only allow water to flow from the flexible hose into the handheld showerhead, and
a locking nut being slightly tapered, being mounted around the base and the connecting assembly and having
an outer end,
an inner end,
a channel being defined longitudinally through the locking nut,
an inner thread being formed adjacent to the inner end of the locking nut and adapted for screwing onto the external thread on the handheld showerhead, and
an inner annular lip being formed on and protruding radially in from the outer end of the channel for holding the flange of the base.

2. The sealing connection assembly as claimed as claim 1, wherein the base further has a gasket being waterproof material and being mounted concentrically on the flange.

3. The sealing connection assembly as claimed as claim 1, wherein the connecting assembly is made of a non-corrosive metal.

4. The sealing connection assembly as claimed as claim 1, wherein the check valve is a seat and disk check valve having
a valve body being tubular and having
an inner surface,
an inner end,
an outer end,
a seat formed on and protruding in from the inner surface of the valve body near the inner end,
an outer annular groove formed in the valve body at the inner end and
an outer O-ring mounted in the outer annular groove to provide a watertight seal between the connecting assembly and the valve body,
a cap being tubular, mounted tightly on the outer end of valve body and having
multiple ribs formed inside the cap and protruding inward, and each rib having an inner end,
a central tube formed on the inner ends of the ribs and extending longitudinally through the cap, and
multiple channels formed respectively between adjacent ribs to allow water to flow through the cap,
a valve disk mounted movably inside the valve body and in the central tube in the cap and having
a valve rod retractable mounted inside the cap, having
an outer end, and
an inner end,
a disk formed on the outer end of the valve rod and having an outer edge,
an inner annular groove defined in the outer edge of the disk, and
an inner O-ring mounted in the inner annular groove and selectively abutting the seat in the valve body, and
a spring mounted around the valve rod between the cap and the valve disk.

5. The sealing connection assembly as claimed as claim 2, wherein the connecting assembly has
two flanges formed on and protruding radially out from the outer surface of the connecting assembly,
an annular recess defined in the outer surface near the proximal end of the connecting assembly,
an annular gasket being resilient and semi-rigid and mounted on the annular recess, and
a flat gasket mounted on the annular gasket.

6. The sealing connection assembly as claimed as claim 3, wherein the connecting assembly is made of copper.

7. The sealing connection assembly as claimed as claim 4, wherein the annular gasket on connecting assembly is made of rubber.

8. The sealing connection assembly as claimed as claim 7, wherein the annular gasket on connecting assembly has a U-shaped cross section and has an open top facing the proximal end of the connecting assembly.
